(19) United States
(12) Patent Application Publication
(10) Pub. No.: US 2004/0143921 A1
(43) Pub. Date: Jul. 29, 2004

(54) Multi-application art tool apparatus for the physically challenged

(76) Inventor: Shari Borkin, Redding, CA (US)

Correspondence Address: Gordon & Rees, LLP, Suite 2075, 300 South Grand Avenue, Los Angeles, CA, 90071, US

(21) Appl. No.: 10/351,095

(22) Filed: Jan. 23, 2003

(51) Int. Cl. A46B 5/02; B25G 1/00

(52) U.S. Cl. 15/106; 15/105; 15/111; 15/143.1; 15/172; 15/144.1; 15/146; 401/6; 401/8

(57) ABSTRACT

A multi-application art tool apparatus for use by paralytic or other physically challenged individuals. The art tool apparatus comprises a rod, at least one strap for attachment, and a plurality of art tools pivotally attached to the end of the rod with a nut and bolt assembly. The nut and bolt assembly allows for easy and multiple positioning of the art tool selected. Different art tools may be easily added or removed from the art tool apparatus.

### BACKGROUND

The field of this invention concerns writing, painting, and drawing apparatuses for paralytics or other physically challenged individuals.

Arthritis, paralysis, muscular dystrophy, polio, birth defects, and other afflictions strike many and may leave the afflicted faced with a myriad of challenges, also faced with the compromised ability or inability to hold and/or manipulate a paintbrush or other art tool as compared to one without the affliction. Mouth brushes allow some paralytic individuals to paint by holding a brush with an elongate handle in their mouth, as taught by U.S. Pat. No. 5,860,754 granted to Garland et al. However, if the individual is able to move an appendage, such as an arm or leg, the individual may prefer to create art using that appendage.

Other apparatuses have allowed individuals with limited mobility to attach a single brush or other art tool to a limb or their head and paint or write. However, changing brushes for different applications of paint or pigment, or changing other art tools for use in various other art media, is frequently desired and employed in the artist's world. The example of changing paintbrushes for different brush stroke effects also may include a painter changing from a paintbrush to a spatula for different paint application techniques. Other examples of artists requiring the change of art tools include: the various spatulas, sponges and various tools used by a potter both when throwing a vessel as well as decorating the vessel as well as the various nibs, pens, pencils, and other color and pigment applicators used by artists for different effects of pigment or coating on a surface.

However, previous attempts at apparatuses that assist a physically challenged individual in the manipulation of an art tool may find that changing paintbrushes, or other art tools, is difficult or impossible. The process of enabling an apparatus to accommodate an art tool may require the disassembly of the apparatus, changing the paintbrush or art tool by either applying and/or releasing pressure to lock and unlock a specially created art tool into place (if such an art tool exists with the required attachment housing) or even temporarily holding the selected art tool in place in the apparatus, and reassembling the apparatus with the newly selected art tool in place. The U.S. Pat. No. 5,791,705 granted to Romero, et al. requires the apparatus to be inserted onto the hand of the individual and a second apparatus be attached to the first apparatus in order that a writing tool may be engaged. The U.S. Pat. No. 5,832,563 granted to Simpson teaches the procedure that a single tool may be engaged at the end of the apparatus, which encircles a large portion of the forearm, by inserting the tool into a housing, tightening the circular housing, and then the individual grip a handle for operation. If the individual using either the Romero et al. or Simpson previous attempts has a need to use a second art tool, the first art tool must be removed and the second art tool inserted, positioned, and locked into place; in the case of U.S. Pat. No. 5,832,563 granted to Simpson, the tool must be of a size accommodated by a threaded “tubular locking shim member”. These prior attempts by Romero, et al and Simpson require manufacturing from specially manufactured parts and therefore may potentially be cost prohibitive for some individuals, rehabilitation centers, or educational institutions.

Although U.S. Pat. No. 2,482,589 granted to Maguire, U.S. Pat. No. 5,451,085 granted to Wagner, and U.S. Pat. No. 5,529,357 granted to Hoffman may not require special manufacturing techniques or the molding of polymers, these prior attempts all teach the selected art tool being guided into two cylindrical housings as well as two threaded assemblies being tightened with a screwdriver or similar device for stabilization of the desired tool within the housings. The use of a screwdriver or similar device requires excellent muscular control and manipulation of tools beyond that required by many art tools, potentially frustrating the efforts of the individual prior to the creation of any art.

The method of stabilizing a tool to U.S. Pat. No. 6,238,358 granted to Philot, et al. is even more involved, and substantially limiting. In order to stabilize an art tool with the prior attempt taught in U.S. Pat. No. 6,238,358, an individual must apply a complex series of multi-directional force applications to the Philot, et al. apparatus to mold the apparatus about the individual's hand, arm or other appendage as well as mold and twist the apparatus about the art tool, thus requiring complex motor skills. However, the Philot et al. prior attempt offers an alternative to the twisting, but requires an individual must possess an art tool with a special attachment housing designed to engage the housing mate at one end of the apparatus molded about the individual's appendage, thus again engaging only one art tool and limiting the selection of types of art tools. Additionally, U.S. Pat. No. 6,101,657 granted to Hamilton requires two hands to operate a paintbrush handle extension with the limitation of a single brush connection to the apparatus. The foldable pen taught in U.S. Pat. No. 4,149,812 granted to Huffinan requires that the pen be grasped in the hand of the user and a rotating manipulation of small parts executed in order to configure the pen in a functioning position. Both of the later-mentioned prior attempts, therefore, require either two handed or difficult manipulations of moving parts in order to use them.

Each of the aforementioned apparatuses taught in the prior attempts for use with appendages requires a disassembly and assembly of the apparatus configuration in order to change art tools. Additionally, several of the above apparatuses require multiple threaded assemblies to be used for art tool stabilization.

An inexpensive and simply manufactured multi art-tooled apparatus that can be operated by an individual with limited use of their physical appendages as well as provide for ease of changing art tools has been needed for art.

### SUMMARY OF THE INVENTION

The design of this art tool apparatus is intended to overcome the aforementioned shortcomings of the prior attempts described above. It is therefore an object of this invention to serve as a multi-application art tool apparatus for physically challenged individuals. The present invention provides for quick and easy selection and application of attachments for painting, writing, and drawing. An elongate member is attached to an appendage, such as an arm, leg or a wheel chair, and the desired paintbrush or art tool is oriented into position for use.

It is a further object of this invention to allow for selection of the desired art tool simply by loosening a threaded nut, rotating the desired paintbrush or art tool into position, and then retightening a threaded nut without the need for any tools.

It is a further object of this invention to enable painting tools, writing tools, drawing tools, sculpting tools, and pottery tools to used by physically challenged individuals for further variation in application of paint or pigments.

It is a further object of this invention to be easily cleaned with water, solvents and/or detergents without excessive damage or wear to the invention.

It is a further object of this invention to provide an inexpensive, simple and effective apparatus from readily available components for various art tool application, art creation, and communication of ideas and expression.

### BRIEF DESCRIPTION OF THE DRAWINGS

FIG. 1 is a perspective view of the multi-application art tool apparatus including three paintbrushes and a flexible strand.

FIG. 2 is a perspective view of the multi-application art tool apparatus including a paintbrush, a spatula, and a putty knife.

FIG. 3 shows an individual in a wheel chair painting with the multi-application art tool apparatus using a paintbrush.

FIG. 4 shows an individual in a wheel chair painting with the multi-application art tool apparatus using the flexible strand.

### DETAILED DESCRIPTION OF THE PREFERRED EMBODIMENTS

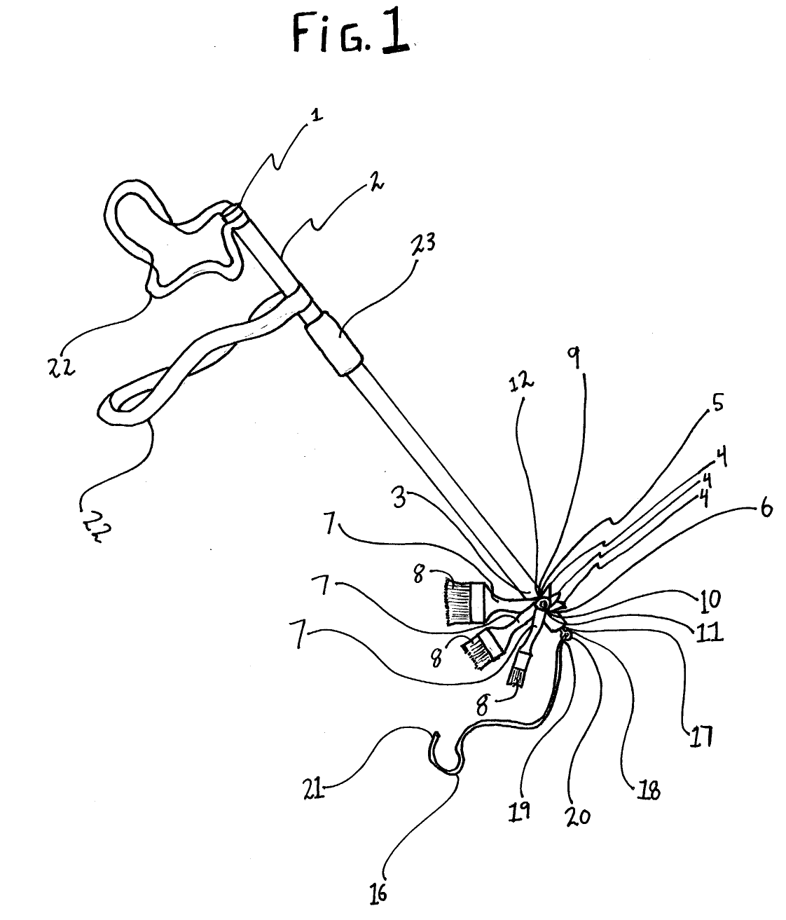

Referring to FIG. 1, the multi-application art apparatus 1 comprises an elongate member 2, preferably a wood or plastic cylindrical rod, with at least one art tool attached at one end 3 of the elongate member, depicted are three paintbrushes 4 attached to the elongate member. The elongate member has a hole 5 towards one end; the paintbrushes also each have a hole 6 through the handle 7 at the end opposite the bristles 8. The holes are large enough to accommodate a threaded bolt 9 that runs through and generally perpendicular to the elongate member and the paintbrush handles. One or more paintbrushes may be substituted for other art tools, such as a spatula 30 or putty knife 31 when painting for paint application technique. A washer 10 is placed adjacent to the bolt head 11 and a second washer 12 placed following the last art tool (as may be referred to herein as “attachment”, or “attachments”). A threaded nut 43, preferably a wing nut, is fastened onto the threaded bolt until sufficiently tight against the attachments and the art tool apparatus to secure the attachments, but yet loose enough for easy threaded nut and washer loosening to change the positions of the attachments or removal for interchanging the attachments. The attachments are individually pivotable about the fulcrum of the threaded nut and threaded bolt assembly generally in parallel planes and also parallel to the elongate member. The threaded nut and threaded bolt assembly is designed to be tightened so that the art tools may be stabilized in a plurality of independent pivotal positions.

A flexible strand 16, preferably cotton string, is attached to the tip 17 of the elongate member at the same end as the attachments are fastened. The flexible strand here is attached with an eyelet screw 18 with one end 19 of the flexible strand tied to the eyelet 20 of the eyelet screw. The other end 21 of the strand is not tied or engaged and is free to dip into paint or pigment and be used to apply the paint or pigment to a surface.

The art tool apparatus is fastened and removed from a general orientation of a mammal's, preferably human's, moveable appendage with at least one, preferably two, flexible members 22, preferably straps or bands. The flexible members, preferably containing a hook and loop type fastener, such as VELCRO®, are releasably fastened to an object, preferably an arm, but may alternatively be releasably fastened to a wheelchair armrest or other object, to stabilize the art tool apparatus and allow for intentional movement of the art tool apparatus. When the session of use of the art tool apparatus has ended, the flexible members can be easily unfastened and the individual released. In addition, a handgrip 23 on the elongate member, preferably a foam-type grip circumscribing the elongate member, may facilitate a firm grip (if the user is able to manipulate their hand or foot in such a manner) for increased control of the art tool apparatus.

Various parts of the art tool apparatus, including the elongate member and attachment handles, or even an entire art tool, may be coated with a sealant to prevent excessive wear and deterioration from solvents and detergents, constant exposure to wetness and drying, and for hygienic purposes.

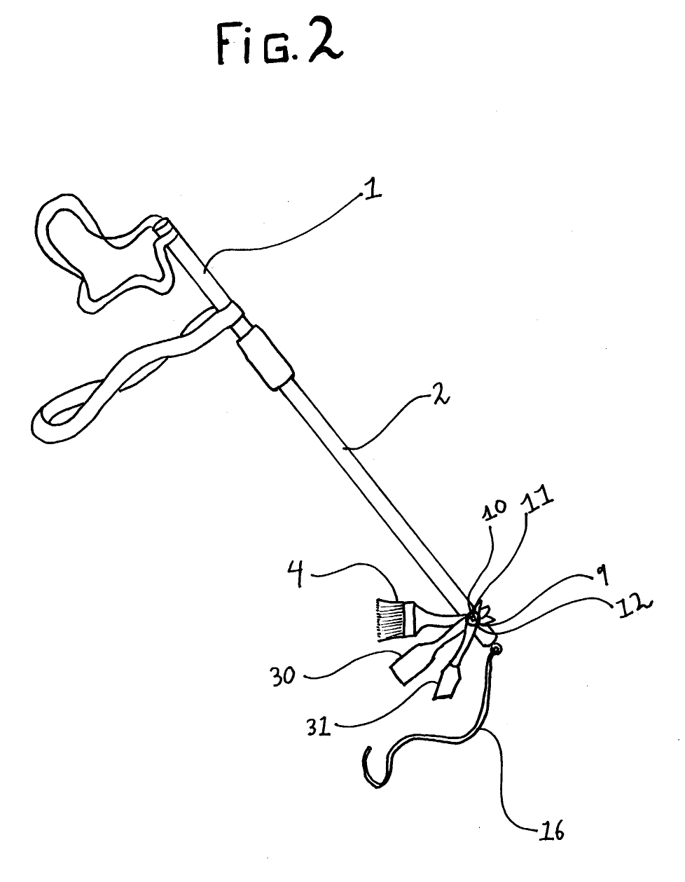

Referring now to FIG. 2, an embodiment of the art tool apparatus 1 is shown with a paintbrush 4, spatula 30 and putty knife 31 attached to the elongate member 2 with the threaded nut and threaded bolt assembly 9, 10, 11, 12, and 43. Art tools may also include writing, drawing, sculpting, and pottery tools. The flexible strand 16 is attached to the elongate member 2.

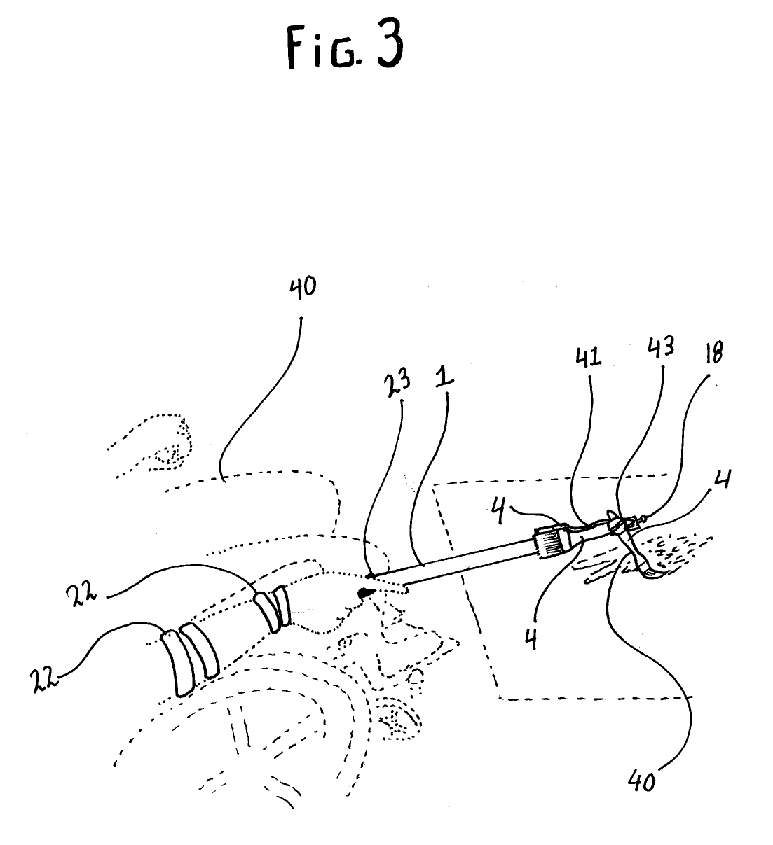

Referring now to FIG. 3, an individual 40 in a wheel chair is painting with the multi-application art tool apparatus 1 using a paintbrush 4. The art tool apparatus is fastened to the arm of the user with two flexible members 21, preferably straps. The user is holding onto a handgrip 23 on the elongate member. One paintbrush has been rotated and stabilized into a first position 40 for painting while the other two brushes are rotated up and away from the brush being used to paint and stabilized in a second position 41. Additionally, the flexible strand 16 has been removed from the eyelet screw 18, but the flexible strand may also be positioned in a manner so as not to interfere with use of the paintbrush, or other art tool, in the first position without removal.

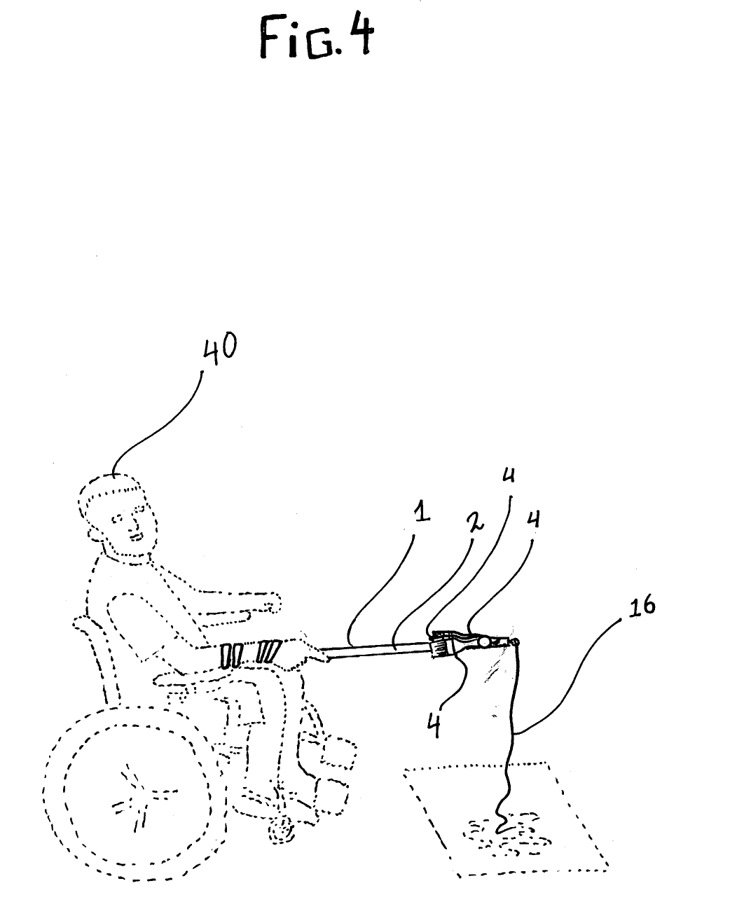

Referring now to FIG. 4 an individual 40 in a wheel chair is painting with the multi-application art tool apparatus 1 using the flexible strand 16, preferably a cotton string. All three paintbrushes 4 have been rotated up and away from the flexible strand being used to paint. The paintbrushes have been stabilized parallel to the elongate member 2.

I claim:

1. A art tool apparatus, comprising:
a. an elongate member with a first and second end;
b. a plurality of art tools with a hole in a handle of each said art tool, said art tools pivotally attached to said first end of said elongate member;
c. a threaded nut, two washers and a threaded bolt assembly bisecting and penetrating said elongate member at said first end with said bolt threads protruding amply to penetrate said art tools through said art tool handle holes and designed to allow said washer and threaded nut to threadably semi-permanently engage said bolt threads in order to stabilize said art tools in a plurality of positions relative to said elongate member by rotating generally in a plane parallel to said elongate member and each other;
d. at least one flexible member affixed to said elongate member designed to fasten and release said elongate member to and in the general orientation of a mammal's moveable appendage;
e. a flexible strand, with a first and second end, said first end of said flexible strand attached to said first end of said elongate member and said second end of said flexible strand freely movable.

2. The art tool apparatus of claim 1, comprising said bolt, washer, and nut assembly designed to semi-permanently engage said art tools in order that one art tool can be oriented in a unique position relative to the other art tools.

3. The art tool apparatus of claim 2, said art tools comprising a member of the group consisting of painting tools, writing tools, drawing tools, sculpting tools, and pottery tools.

4. The art tool apparatus of claim 3, comprising a plurality of at least two different members of said group of art tools.

5. The art tool apparatus of claim 1, comprising at least one flexible member to. releasably fasten to a wheel chair.

6. An art tool apparatus, comprising:
a. an elongate member with a first and second end;
b. a plurality of paintbrushes, said paintbrushes each with a handle and with a hole in each said paint brush handle, said brushes pivotally attached to said first end of said elongate member;
c. a threaded nut, two washers and a threaded bolt assembly bisecting and penetrating said elongate member at said first end with said bolt threads protruding amply to penetrate said paint brushes through said paint brush handle holes and designed to allow said washer and threaded nut to threadably semi-permanently engage said bolt threads in order to stabilize said paintbrushes in a plurality of unique positions relative to said elongate member by rotating generally in a plane parallel to said elongate member and each other;
d. at least two flexible members affixed to said elongate member designed to fasten and release said elongate member to and in the general orientation of a mammal's moveable appendage;
e. an interchangeable flexible strand with a first and second end, said first end of said flexible strand attached to said first end of said elongate member and said second end of said flexible strand freely movable.

7. The art tool apparatus of claim 6, comprising a liquid and solvent resistant sealant having been selectively applied to said elongate member.

8. The art tool apparatus of claim 7, comprising said elongate member being a cylindrical rod.

9. The art tool apparatus of claim 8, comprising a handgrip attached to said elongate member.

10. The art tool apparatus of claim 6, comprising interchangeable paintbrushes.

11. The art tool apparatus of claim 10, comprising an eyelet screw affixed to said first end of said elongate member designed to be releasably engaged by said flexible strand.

12. The art tool apparatus of claim 6, comprising a liquid and solvent resistant sealant having been selectively applied to said paintbrush handles.

13. An art tool apparatus, comprising:
a. a liquid and solvent resistant elongate cylindrical rod with a first and second end, said elongate cylindrical rod having a handgrip;
b. a plurality of interchangeable paintbrushes, said paintbrushes each with a handle and with a hole in each said paintbrush handle, said paintbrushes being pivotally attached to said first end of said elongate cylindrical rod and said paintbrush handles being liquid and solvent resistant;
c. a threaded wing nut, two washers and a threaded bolt assembly bisecting and penetrating said elongate cylindrical rod at said first end with said bolt threads protruding amply to penetrate said paintbrushes through said paintbrush handle holes and designed to allow said washer and threaded wing nut to threadably semi-permanently engage said bolt threads in order to stabilize said paint brushes in a plurality of unique positions relative to said elongate cylindrical rod by rotating generally in parallel planes and parallel to said elongate cylindrical rod;
d. at least two flexible members, each with hook and loop fasteners, affixed to said elongate cylindrical rod designed to fasten and release said elongate cylindrical rod to and in the general orientation of a mammal's moveable appendage;
e. an eyelet screw affixed to said first end of said elongate cylindrical rod designed to be releasably engaged by a flexible strand;
f. an interchangeable flexible strand with a first and second end, said first end of said flexible strand releasably attached to said eyelet screw and said second end of said flexible strand freely movable.

14. The art tool apparatus of claim 13, comprising said flexible members designed to releasably engage a wheel chair.

15. The art tool apparatus of claim 13, said flexible member comprising cotton string.
